(19) United States
(12) Patent Application Publication
(10) Pub. No.: US 2026/0169572 A1
(43) Pub. Date: Jun. 18, 2026

(54) SYSTEM AND METHOD FOR CONTROLLING A MAN-MACHINE INTERFACE FOR A VEHICLE

(71) Applicant: Faurecia Interieur Industrie, Nanterre (FR)

(72) Inventors: Fernandez RAYAR, BEAUVAIS (FR); Zakariyae LAMRABET, CERGY (FR)

(21) Appl. No.: 19/422,316

(22) Filed: Dec. 16, 2025

(30) Foreign Application Priority Data
Dec. 16, 2024 (FR) FR 24 14211

(51) Int. Cl. G06F 3/01; B60K 35/10; B60K 35/22; B60K 35/81; B62D 1/04; G06F 3/0482; G06F 3/0485

(52) U.S. Cl. CPC G06F 3/017; B60K 35/10; B60K 35/22; B60K 35/81; B62D 1/04; G06F 3/0482; G06F 3/0485; B60K 2360/113; B60K 2360/115

(57) ABSTRACT

A control system that includes a detector configured to detect a movement in a detection zone associated with a vehicle steering wheel, notably a movement of at least one finger of a vehicle driver in the detection zone; and a control unit, connected to the detector and to a display interface. The control system is configured to: activate a menu display control on the display interface following a detection of a first movement of at least one of the driver's fingers directed towards the display interface; following a detection of a second movement of the at least one driver's finger in a first substantially horizontal or vertical direction, scroll through the menus on the display interface based on the second detected movement, with a menu being selected when the driver stops the second movement, and receive a command to validate the selected menu and activate the selected menu.

### TECHNICAL FIELD

The present invention relates to a system for controlling a man-machine interface for a vehicle.

It also relates to an associated method for controlling a man-machine interface for a vehicle.

### BACKGROUND

In recent vehicles, in particular in motor vehicles, a growing number of functionalities are offered to the driver, by the use of buttons, and a large amount of information is displayed on the display interfaces of the vehicle.

In general, vehicles, notably motor vehicles, comprise a dashboard and a steering wheel for drivers, as well as various controls for driving the vehicle. Furthermore, the vehicles are equipped with numerous buttons and actuators, located close to the steering wheel or directly on the steering wheel, to control additional functionalities associated with driving the vehicle as well as complementary functionalities, such as selecting an audio source, adjusting volumes, or changing the screen on a display interface. The plurality of numerous buttons and actuators is likely to increase the mental load of the driver, and therefore increase the risk of distraction while driving.

Touch-screen display interfaces have also been proposed for vehicles. However, manipulating such display interfaces requires moving one hand towards the touchscreen and therefore letting go of the steering wheel, which is not recommended from a vehicle driving safety point of view.

Generally, it is desirable to improve the man-machine interfaces and make it easier to select and control the various functionalities on offer. For the driver of a vehicle, it is particularly important to make the controls easy and to improve the ergonomics, in order to reduce their mental load, and as a result improve safety when driving the vehicle.

### SUMMARY

An object of the present invention is to provide a solution by offering a system for controlling a man-machine interface for a vehicle that is easy for the vehicle driver to use, without interfering with vehicle driving safety.

To this end, there is provided herein a system for controlling a man-machine interface for a vehicle, the vehicle comprising a steering control wheel, intended to be manipulated by a driver of the vehicle, and a display interface, the control system comprising a detector configured to detect a movement in a detection zone associated with the steering wheel, the detector being configured to detect a movement of at least one finger of the driver of the vehicle in said detection zone, the control system comprising a control unit, connected to said detector and to the display interface, the control unit being configured to:
activate a menu display control on the display interface following a detection of a first movement of at least one finger of the driver directed towards the display interface, each menu being associated with at least one command,
following a detection of at least a second movement of said at least one driver's finger in a first, substantially horizontal or vertical direction, scroll through the menus on said display interface based on said at least one second movement detected, said second movement being different from said first movement, a menu being selected when the driver stops said second movement,
receive a command to validate said selected menu and activate the selected menu.

Advantageously, the proposed man-machine interface control system can detect first and second movements of one or more of the driver's fingers with respect to the display interface. Thus, the driver of the vehicle can easily scroll through and select a menu and activate the selected menu, while keeping their hands on the steering wheel.

According to other advantageous aspects of the invention, the man-machine interface control system comprises one or more of the following features, taken alone or in any technically feasible combination.

The validation command is performed by at least a third movement of said at least one driver's finger in a second direction, substantially perpendicular to the first direction.

The validation command is performed via a validation member.

The receipt of the validation command comprises a validation display of said selected menu at a predetermined main location on said display interface, said predetermined main location is located in line with said at least one driver's finger.

The detector is an infrared sensor.

The detector is integrated into a trim element of the vehicle.

The detector is elongated, said detector is arranged in a horizontal shelf of the vehicle, or said detector is arranged in a support element of the steering wheel.

The detector extends horizontally from one lateral side of the steering wheel, enabling a detection of movements made by one or more of the driver's fingers when the driver has their hand on said lateral side of the steering wheel.

The invention also relates to a method for controlling a man-machine interface for a vehicle implemented by a control system as disclosed hereinbefore, the method comprising the following steps:
activating a menu display control on the display interface following a detection of a first movement of at least one finger directed towards the display interface, each menu being associated with at least one command,
following a detection of at least a second movement of said at least one driver's finger in a first, substantially horizontal or vertical direction, scroll through the menus on said display interface based on said at least one second movement detected, said second movement being different from said first movement, a menu being selected when the driver stops said second movement,
receiving a command to validate the selected menu and
activating the selected menu.

According to another aspect, the invention also relates to a vehicle equipped with a man-machine interface control system as briefly disclosed hereinbefore.

### BRIEF DESCRIPTION OF THE DRAWINGS

The invention will become clearer on reading the following description, given solely by way of non-limiting example, and made with reference to the drawings, wherein:

FIG. 1 is a schematic perspective view of a vehicle cab part comprising a man-machine interface control system;

FIG. 2 is a block diagram of the main functional blocks of a man-machine interface control system according to one embodiment;

FIG. 3 is a schematic representation of components of a man-machine interface control system according to a first embodiment;

FIG. 4 is a schematic representation of components of a man-machine interface control system according to a second embodiment, and

FIG. 5 is a schematic cross-sectional view showing, in separate inserts A, B and C, driver's finger movements detected by the man-machine interface control system.

### DETAILED DESCRIPTION

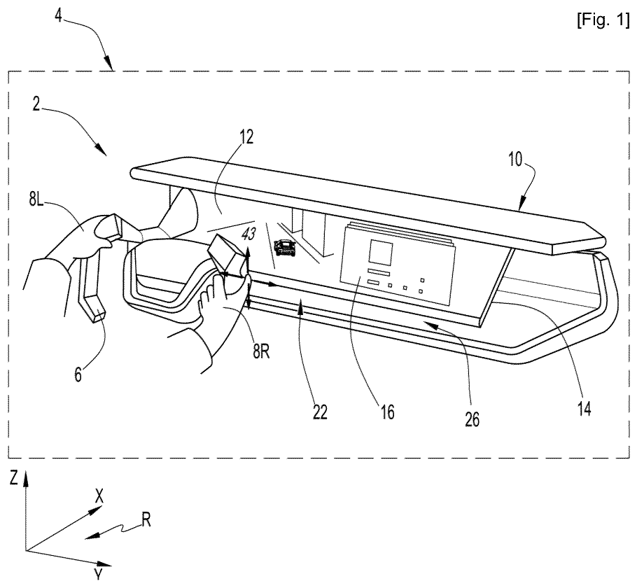

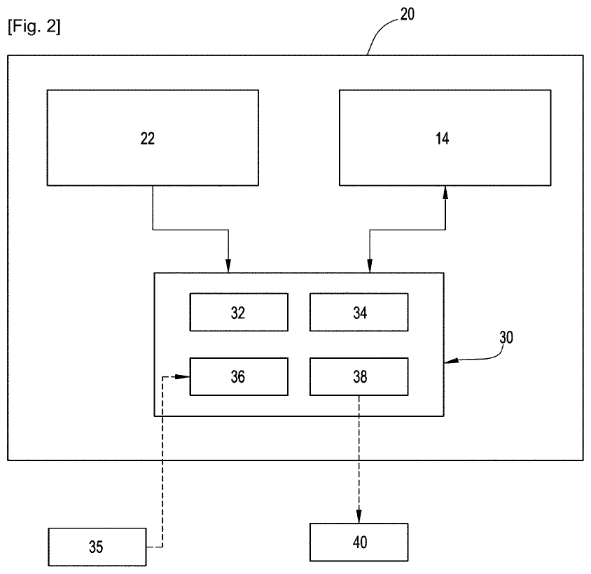

FIG. 1 shows a part 2 of a cab of a vehicle 4 equipped with a man-machine interface control system. The invention is applicable to all types of vehicles, particularly motor vehicles.

The vehicle comprises a steering control wheel 6, hereinafter referred to simply as a steering wheel 6, used to control the direction of travel of the vehicle by a driver positioned in a driver's seat (not shown). The driver manipulates the steering wheel 6 with their hands, respectively their right hand 8R and their left hand 8L.

The vehicle 4 comprises a trim element 10, into which a dashboard 12 comprising a display interface 14 is inserted.

Information and control menus are displayed on the display interface 14, one command being associated with a display of a sub-menu or with the operation of vehicle equipment.

In the example shown, the display interface 14 comprises a surface 16, on the vehicle interior side, which is inclined with respect to the vertical direction indicated by a Z axis of a three-dimensional reference frame R. The three-dimensional reference frame R is an orthogonal spatial reference frame, comprising a first axis X extending towards the front of the vehicle, a second axis Y orthogonal to the first axis X, the axes (X, Y) defining a horizontal plane and a vertically extending third axis Z orthogonal to the horizontal plane.

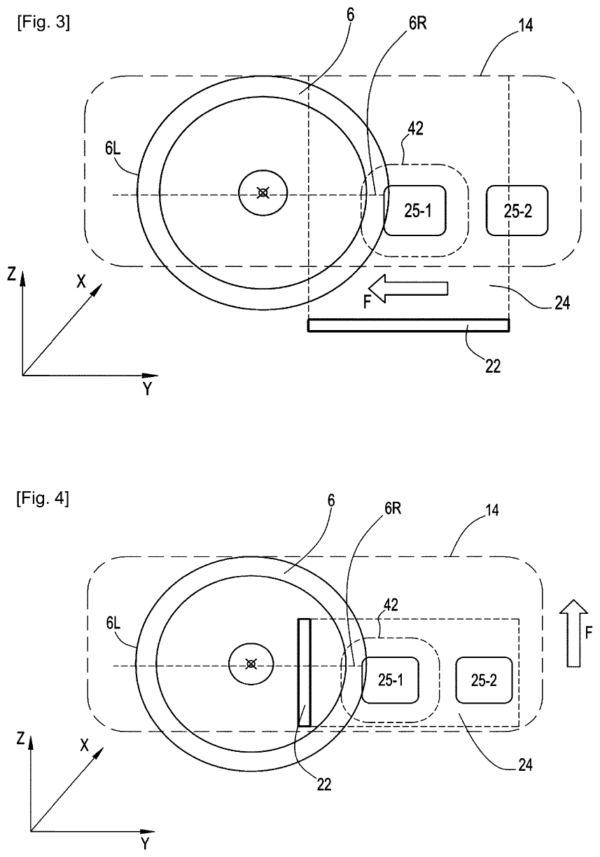

Preferably, and as shown on FIGS. 3 and 4, at least a part of the surface 16 of the display interface 14 faces the steering wheel 6, or faces a lateral side of the steering wheel, for example the right lateral side.

The vehicle 4 is equipped with a man-machine interface control system 20, which will be disclosed in more detail below.

The man-machine interface comprises the display interface 14 and actuators for vehicle equipment such as for example loudspeakers, heating/air conditioning systems, ventilation systems and lighting systems.

The control system 20 comprises a detector 22 configured to detect a movement in an associated detection zone 24.

Advantageously, the detector 22 is an infrared detector, comprising at least one light source in the infrared range, for example in the near infrared range in the 700 to 2500 nm wavelength range.

In one embodiment, the detector 22 has a shape of an elongated bar, extending longitudinally in a main direction. Preferably, the detector 22 has a length between 5 cm and 20 cm, for example equal to 10 cm.

According to one embodiment, the detector 22 comprises a plurality of infrared sensors, arranged in a line, in the longitudinal direction of the detector, with two successive sensors spaced apart by a predetermined distance.

In one embodiment, as shown in FIG. 1, the detector 22 is arranged in a horizontally extending (parallel to the plane (X,Y) of the reference frame R) support shelf 26 of the trim element 10, so as to illuminate at least a part of the steering wheel. In one embodiment, the detector 22 extends longitudinally substantially parallel to the Y axis of the reference frame F.

For example, the detector is positioned in the vicinity of a lateral side of the steering wheel 6, for example in the vicinity of the right lateral side 6R of the steering wheel 6. An example of how to position the detector 22 with respect to the steering wheel 6 is shown in FIG. 3.

In this embodiment, the detector 22 comprises an infrared light source configured to illuminate in the vertical direction, the associated detection zone 24 being a frustoconical zone including the lateral side of the steering wheel.

Alternatively, and as shown in the example of FIG. 4, the detector 22 is arranged in a trim element located behind the steering wheel 6 and in the vicinity of the steering wheel 6, for example a support element of the steering wheel 6, in a substantially vertical plane, with the detector 22 extending longitudinally parallel to the Z axis (vertical axis) of the reference frame R.

Advantageously, by virtue of the arrangement and of the shape of the detector 22, the associated detection zone 24 can detect the respective movements of one or more fingers of the vehicle driver when the driver's hands are on the steering wheel.

For example, the control system detects the movement of one or two of the driver's fingers, the index and/or the middle finger, of the hand (e.g, the right hand) which faces the detection zone 24 when it is positioned on the steering wheel 6.

The control system 20 comprises a control unit 30 which is connected, for example via a wired communication bus, to the detector 22 and to the display interface 14.

The control unit 30 is a programmable electronic unit, for example a microcontroller.

The control unit 30 is configured to receive motion detection information from the detector 22.

The motion detection information received indicates or enables calculation of a direction of movement of an object, notably the driver's fingers, in the detection zone, from the respective directions X, Y and Z.

The control unit 30 is further connected to the display interface 14, and is configured to control and modify the display on the display interface, notably to control the display location of menus, each menu being associated with a command.

The control unit 30 is configured to implement a module 32 for activating the control of the menu display on the display interface following a detection of a first movement of one or more of the driver's fingers directed towards the display interface, that is, substantially in the direction of the X axis.

For example, starting from an initial position in which the driver has their hands on the steering wheel and their fingers around the steering wheel 6, the driver unfolds one or more fingers, for example the index and/or the middle finger, in the direction of the display interface. Detection of this first movement activates the menu display control.

Furthermore, the control unit is configured to implement a module 34 for activating the scrolling of displayed menus based on at least a second movement, detected by the detector 22, of the driver's finger(s) in a first direction, either horizontal or vertical.

Menu scrolling consists of modifying the display on the display interface to place each menu successively at a selected main location 42.

The scrolling is thus advantageously controlled by the second movement of the driver's finger(s).

Finally, the control unit is configured to implement a validation module 36 configured to receive a validation command for a selected menu and validate the selected menu. The selected menu is for example the menu displayed at the main location 42 in the display zone.

In one embodiment, the validation command is for example performed by a third movement of the driver's fingers in a second direction distinct from, and preferably perpendicular to, the first direction.

Alternatively, the validation command is performed by means of a validation member 35, for example a pushbutton located on the steering wheel 6 or in the vicinity of the steering wheel 6.

Following the validation of the selected menu, the control unit is configured to implement a module 38 to activate the command associated with the selected menu.

Activating the command either modifies the display on the graphic interface, or modifies the behavior of a piece of equipment 40 onboard the vehicle, by sending a signal to the actuator of the equipment 40. The equipment 40 is for example a loudspeaker, a heating/air conditioning system, a lighting system.

For example, in the case of a selection menu for an audio source to be played through the vehicle's speakers, the command selects the audio source (e.g. radio, external source connected via a communication link).

Alternatively or additionally, the command associated with a menu leads to the development of sub-menus. For example, after selecting an audio source, sub-menus are displayed, these sub-menus making it possible to specify the audio source selection, for example a radio channel or an audio track (e.g. a musical title) to be played.

In one embodiment, the modules 32, 34, 36; 38 are each made in the form of programmable logic components, such as FPGAs (Field-Programmable Gate Arrays), microprocessors, GPGPU components (General-Purpose Processing on Graphics Processing), or even dedicated integrated circuits, such as ASICs (Application-Specific Integrated Circuits).

In one embodiment, the modules 32, 34, 36; 38 are made in the form of software instructions forming a computer program, which, when executed by a computer, implements a method for controlling a man-machine interface for a vehicle.

By way of example, in a first embodiment shown in FIG. 3, the detector 22 is positioned on the right lateral side of the steering wheel 6, referenced 6R, so as to enable the detection of movement of the fingers of the driver's right hand when their right hand is positioned on the steering wheel 6.

The graphical interface 14 displays menus 25-1, 25-2 etc., for example in the form of graphical items (icons, text, logos etc.).

For example, when the driver performs a second movement in the direction of the arrow F (substantially parallel to the Y axis in this first embodiment), the menu 25-1 is replaced by the menu 25-2 in the main location 42. In other words, the direction of the second movement indicates a menu rotation direction, from right to left or vice versa.

The main location 42 is preferably in line (that is, along direction X) with the finger or fingers whose movement is detected.

Alternatively or additionally, the main location is marked graphically, for example by highlighting, contrast modification or another graphic mark.

Alternatively, in a second embodiment shown in FIG. 4, the detector 22 is located on the right lateral side of the steering wheel 6, referenced 6R, with the detector 22 extending longitudinally substantially vertically. The detector 22 illuminates the detection zone 24. In this second embodiment, when the driver performs a second movement in the direction of the arrow F (a substantially vertical movement, parallel to the Z axis in this second embodiment), the menus displayed scroll vertically. The direction of rotation of the menu display, from top to bottom or from bottom to top, is indicated by the direction of movement of the fingers.

As in the first embodiment, the main location 42 is preferably located in line (that is, along direction X) with the finger or fingers whose movement is detected.

Alternatively or additionally, the main location is marked graphically, for example by highlighting, contrast modification or another graphic mark.

Of course, an analogous operation can be envisaged, for each of the embodiments, to carry out commands by movements of one or more fingers of the driver's left hand, by placing the detector 22 on the left lateral side 6L of the steering wheel 6.

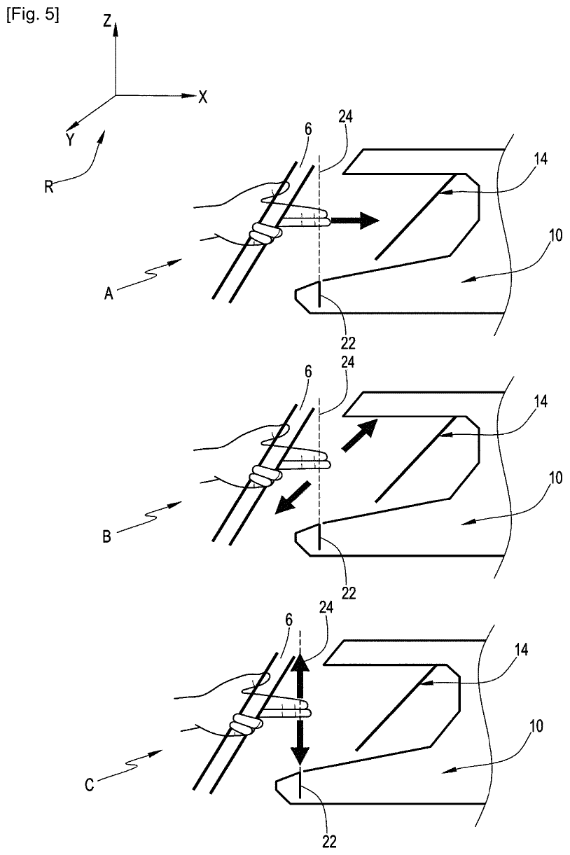

In one embodiment, it is envisaged to detect a first movement of one or two of the driver's fingers in direction X, towards the display interface, to activate the menu display control, as shown in insert A of FIG. 5.

A detection of a second substantially horizontal movement of the driver's finger(s) in the Y direction (see insert B of FIG. 5) induces scrolling through the menus on the display interface.

For example, the direction of scrolling is indicated by the direction of the second movement of the driver's fingers, to the right or to the left. Based on the scrolling direction selected, the menu positioned to the right or to the left of the menu displayed at the main location is displayed instead thereof. In this embodiment, the scrolling is performed step-by-step based on each second movement of the driver's finger(s).

A detection of a third substantially vertical finger movement in the Z direction (see insert C of FIG. 5), distinct from the first and second movements, validates the menu displayed at the main location as the selected menu, and then induces the activation of the command associated with the selected menu.

Of course, alternatively, the scrolling is controlled by second movements of the driver's fingers in the Z direction (vertical direction), and the direction of scrolling is either downwards or upwards, depending on the direction of the second movement of the driver's fingers, and optionally, the validation is controlled by a third movement of the fingers substantially parallel to the Y axis.

The control system is configured to implement a method for controlling a graphical interface, the method comprising the following steps:
activating a menu display control on the display interface following a detection of a first movement of at least one finger directed towards the display interface, each menu being associated with at least one command,
following a detection of a second movement of said at least one driver's finger in a first substantially horizontal or vertical direction, scrolling through the menus on said display interface based on the second movement detected, said second movement being different from said first movement, a menu being selected when the driver stops said second movement,
receiving a command to validate the selected menu and activating the selected menu.

Advantageously, the proposed control system enables simplified easy control for a vehicle driver to remotely select menus on a touchless graphical interface, and activate commands to modify the display and/or vehicle equipment by simple finger movements.

1. A control system for a man-machine interface of a vehicle that has a steering control wheel, intended to be manipulated by a driver of the vehicle, and a display interface, wherein the control system comprises:
a detector configured to detect a movement in a detection zone associated with the steering wheel, the detector being configured to detect a movement of at least one finger of the vehicle driver in said detection zone; and
a control unit, connected to said detector and configured to connect to the display interface of the vehicle, the control unit being configured to:
activate a menu display control on the display interface following a detection of a first movement of at least one finger of the driver directed towards the display interface, each menu being associated with at least one command,
following a detection of at least a second movement of said at least one driver's finger in a first substantially horizontal or vertical direction, scrolling through the menus on said display interface based on said at least one second movement detected, said second movement being different from said first movement, a menu being selected when the driver stops said second movement,
receive a command to validate said selected menu, and
activate the selected menu.

2. The control system according to claim 1, wherein the validation command is performed by at least a third movement of said at least one driver's finger in a second direction, substantially perpendicular to the first direction.

3. The control system according to claim 1, wherein the validation command is performed via a validation member.

4. The control system according to claim 1, wherein the receipt of the validation command comprises a validation display of said selected menu at a predetermined main location on said display interface, said predetermined main location is located to the right of said at least one driver's finger.

5. The control system according to claim 1, wherein said detector is an infrared detector.

6. The control system according to claim 1, wherein said detector is integrated into a trim element of the vehicle.

7. The control system according to claim 1, wherein said detector is elongated, said detector is arranged in a horizontal shelf of the vehicle, or said detector is arranged in a support element of the steering wheel.

8. The control system according to claim 7, wherein said detector extends horizontally from a lateral side of the steering wheel, enabling a detection of movements made by one or more of the driver's fingers when the driver has their hand on said lateral side of the steering wheel.

9. A method for controlling a man-machine interface for a vehicle implemented by the control system according to claim 1, the method comprising the following steps:
activating a menu display control on the display interface following a detection of a first movement of at least one finger directed towards the display interface, each menu being associated with at least one command,
following a detection of at least a second movement of said at least one driver's finger in a first, substantially horizontal or vertical direction, scroll through the menus on said display interface based on said at least one second movement detected, said second movement being different from said first movement, a menu being selected when the driver stops said second movement,
receiving a command to validate the selected menu and
activating the selected menu.

10. A vehicle equipped with the control system according to claim 1.
